(19) United States
(12) Patent Application Publication
(10) Pub. No.: US 2023/0263109 A1
(43) Pub. Date: Aug. 24, 2023

(54) FROST PROTECTION SYSTEM

(71) Applicant: FROLIGHT BV, Gavere (BE)

(72) Inventor: Alexander SCHMIDT, Gavere (BE)

(21) Appl. No.: 18/017,548

(22) PCT Filed: May 7, 2021
(86) PCT No.: PCT/IB2021/000312

§ 371 Date: Jan. 23, 2023

(30) Foreign Application Priority Data
Jul. 27, 2020 (BE) BE2020/5549

(51) Int. Cl. A01G 13/06; A01G 17/02; A01G 7/04

(52) U.S. Cl. CPC A01G 13/06; A01G 17/02; A01G 7/045

(57) ABSTRACT

A frost protection system for protecting new growth or new plantings from frost includes one or more light strings for irradiating the new growth or new planting to be protected from frost, a power supply for supplying the light strings with electrical power and a thermal control unit for controlling the power supply on the basis of measured temperature. The one or more light strings have at least four lights per linear meter.

### TECHNICAL FIELD

The invention relates to frost protection systems for protecting new growth and new plantings from frost, in particular to frost protection systems for grapevines, and to methods for preventing frost damage to new growth and new plantings, inter alia new shoots on grapevines.

### PRIOR ART

Growing grapes as the raw material for wine production is as old as humanity itself. Grapes have been cultivated for centuries in order to make wine from the juice.

Viticulture, and the growing of grapevines, is a science in itself. The grapevines have to be particularly closely monitored during the annual growing season, in order to obtain an optimal grape yield. However, one of the greatest hazards when growing grapes is not within human control. Grapevines burst into bud in the spring. The grapevines are pruned back to the wood of a few fruiting laterals. In the spring, young new shoots appear on these fruiting laterals which go on to bear the bunches of grapes. A spell of late frost in the spring can damage the new shoots and even kill them off. This dramatically decreases the number of bunches of grapes that can be harvested that year after the summer.

There are two types of such frosty spells, with temperatures slightly below freezing, which can occur in the spring. A first type is a frosty spell that occurs when there is no cloud cover at all. The ground loses heat through radiation to slightly below freezing. This is known as radiation frost. Another type of frost is that which is caused by cold winds picking up which often come from the polar region. Such frosty spells are spells of advection frost. Both types can also occur together.

There have been many attempts to protect the new shoots from dying off during such, often short and overnight, frosty spells. The use of smudge pots in the vineyard which are lit between the rows of grapevines is known. The use of fans that displace higher, warmer layers of air downward is also known.

Also known is the method of spraying the grapevines with water, in order to keep the temperature of the new shoots at 0° C. thereby. However, the required amount of water is significant and often underestimated or insufficient in the event of longer frosty spells or several frosty nights one after the other.

More recently, experiments have been carried out with electrical resistance wires which are positioned in the vicinity of the fruiting laterals. An example of this is FR3074995A1.

Few of such solutions are capable of overcoming both radiation frost and advection frost and effectively protecting the fruiting laterals from frost damage.

New plantings can also suffer damage from frost in the spring for the same reasons. New plantings such as of lettuce, cabbage and the like can be damaged or even killed off by a frosty night.

### SUMMARY OF THE INVENTION

According to a first aspect of the invention, a frost protection system is provided.

A frost protection system for protecting new growth or plantings from frost, for example for protecting new shoots or buds, for example on grapevines, according to the first aspect of the invention comprises one or more light strings for irradiating growth, plantings, fruiting laterals or buds on fruiting laterals, for example of grapevines, from frost. The system may further comprise a power supply for supplying the light strings with electrical power. The system may further comprise a thermal control unit for controlling the power supply on the basis of measured temperature.

According to a preferred embodiment, a frost protection system for protecting new growth or new plantings from frost comprises
one or more light strings for irradiating the new growth or new planting to be protected from frost;
a power supply for supplying the light strings with electrical power;
a thermal control unit for controlling the power supply on the basis of measured temperature
   wherein the one or more light strings have at least four lights per linear meter.

For example, the new growth or new planting is new shoots on the fruiting laterals of grapevines. What is meant by new growth is new buds (leaf or fruiting buds) and/or shoots that are growing on the plant.

Such a frost protection system for protecting grapevines from frost comprises
one or more light strings for irradiating the fruiting laterals of grapevines to be protected from frost;
a power supply for supplying the light strings with electrical power;
a thermal control unit for controlling the power supply on the basis of measured temperature
   wherein the one or more light strings have at least four lights per linear meter.

In the context of this invention, a light string refers to a plurality of lights, such as LED bulbs or incandescent bulbs, that are arranged on a string comprising at least two electrical conductors, and they are all electrically connected in parallel by supplying current over some or all of the conductors of the string. A light string may be a light garland, a light rope or a light strip, inter alia. The light strings may have at least four lights per linear meter.

The frost protection system is preferably usable for protecting new shoots on laterals of grapevines. Given that the internode on grapevines is approximately 25 cm at most, and is often smaller, the minimum number of lights per linear meter is related to this maximum distance between consecutive buds on the lateral. Preferably, the distance between the lights is smaller than this maximum internode. For example, the light strings comprise between five and 100 lights per linear meter, e.g. between 20 and 80 lights per linear meter, preferably 30 to 80 lights per linear meter, more preferably 40 to 80 lights per linear meter.

More preferably, the light string has between 50 and 80 lights per linear meter, such as between 60 and 75 lights per linear meter.

According to some embodiments, the light string may have a power of between 10 and 50 watts per linear meter, for example between 10 and 30 watts per linear meter, e.g. between 10 and 20 watts per linear meter.

According to some embodiments, the light string may have lights that are formed by an incandescent filament. In other words, the lights may be incandescent bulbs. According to some embodiments, the light string may have lights that comprise incandescent bulbs.

According to some embodiments, the incandescent bulbs may be infrared bulbs.

All of the incandescent bulbs may be identical and emit essentially the same light frequency spectrum, or the incandescent bulbs may comprise different incandescent bulbs that emit different light frequency spectra.

According to other embodiments, the lights may be halogen bulbs.

According to some embodiments, the light string may have lights that are formed of LED bulbs.

According to some embodiments, the LED bulbs may be infrared LED bulbs.

All of the LED bulbs may be identical and emit essentially the same light frequency spectrum, or the LED bulbs may comprise different LED bulbs that emit different light frequency spectra.

Although, according to some embodiments of the invention, the maximum intensity of the emitted light may be in the visual range, a radiation that is more in the infrared range is preferred.

According to some embodiments, the maximum intensity of the emitted light may be in the infrared range.

The infrared range is the range of the electromagnetic spectrum in which the wavelength is between 780 nm and 1 mm. Preferably, the maximum intensity of the emitted light is in the near-infrared, which is radiation with a wavelength of between 0.78 and 3 μm. The maximum intensity of the emitted light is possibly in the mid-infrared, which is radiation with a wavelength of between 3 and 50 μm.

The light strings may comprise supply wires. To deliver power to the lights, the light string comprises at least two current conductors, which are connected to the two poles of the electrical power supply. The light string potentially comprises a third electrical conductor which is connected to ground. These two or three electrical conductors may be present along the entire light string, for example light rope, light strip or light garland. This is important in particular for safety reasons, in case a worker is cutting between the plants for which the frost protection system is used. If the light string is accidentally cut, electrocution of the worker is prevented thereby. Preferably, the light strings are supplied with AC power, for example 230 V AC. However, DC and/or use of a lower voltage is also possible.

The light string is possibly chosen from the group consisting of a light garland, a light rope and a light strip. The light string is possibly chosen from the group consisting of a light rope and a light strip.

According to some embodiments, the light string may be a light garland.

Light garlands often have incandescent bulbs as a light source. A plurality of incandescent bulbs may be connected in parallel or in series on two or three electrical conductors. The incandescent bulbs may be infrared incandescent bulbs. Alternatively, halogen bulbs may be used.

All of the incandescent bulbs may be identical and emit essentially the same light frequency spectrum, or the incandescent bulbs may comprise different incandescent bulbs that emit different light frequency spectra.

According to some embodiments, the light string may be a light rope.

According to a second independent aspect, a frost protection system for protecting new growth or new plantings from frost is provided, the frost protection system comprising
one or more light ropes for irradiating the new growth or new planting to be protected from frost;
a power supply for supplying the light strings with electrical power;
a thermal control unit for controlling the power supply on the basis of measured temperature.

Each of these one or more light ropes possibly comprises at least four lights per linear meter, for example between five and 100 lights per linear meter, e.g. between 20 and 80 lights per linear meter, preferably 30 to 80 lights per linear meter, more preferably 40 to 80 lights per linear meter.

A light rope is a rope, made of a transparent polymer rope, in which there is a plurality of lights. The lights may be LED bulbs, halogen bulbs or incandescent bulbs.

Preferably, “rope lights” are used, with a cylindrical cross section.

According to some embodiments, the light string may be a light strip.

According to a third independent aspect, a frost protection system for protecting new growth or new plantings from frost is provided, the frost protection system comprising
one or more light strips for irradiating the new growth or new planting to be protected from frost;
a power supply for supplying the light strings with electrical power;
a thermal control unit for controlling the power supply on the basis of measured temperature.

Each of these one or more light strips possibly comprises at least four lights per linear meter, for example between five and 100 lights per linear meter, e.g. between 20 and 80 lights per linear meter, preferably 30 to 80 lights per linear meter, more preferably 40 to 80 lights per linear meter.

A light strip is often a polymer strip, which may or may not be transparent, on which LED bulbs or similar lights are mounted.

Optionally, lights are present on one side or on both sides of the light strip. Potentially, a light strip may be used that has a radial cross section with more than two sides suitable for the attachment of lights, for example a triangular, quadrangular, pentagonal, hexagonal or other polygonal cross section. One, two or more of these sides, for example all sides, may be provided with lights.

Preferably, copper light strips are used with LED bulbs with 5050- or 3528-type packages. There is a watertight coating around the LED strip, usually made of polyester or another polymer, which is preferably transparent.

According to some embodiments, the frost protection system may be a system for protecting new growth on grapevines from frost. It may be a system for protecting new growth on kiwifruit plants from frost. It may be a system for protecting new growth on fruit trees and shrubs, such as apple trees, pear trees, olive trees, banana plants, trees of the genus Prunus, such as plum trees, apricot trees, nectarine trees, sweet cherry trees, sour cherry trees and preferably trees or shrubs in the form of espaliered trees or shrubs from frost.

The frost protection system comprises one or more light strings. These may be connected in such a way that the light strings together form one long light string that will provide all rows of new plantings or grapevines with light in series. Alternatively, the frost protection system comprises several light strings connected in star configuration, in which one light string will provide one new planting or a group of new plantings or one grapevine or a portion of a row of grapevines with light.

Each group of new plantings or each grapevine may also be provided with more than one light string for protection from frost. In the case of more than one light string per group of new plantings or grapevine, a first light string may be supplied with power in the event that the temperature falls below a first threshold temperature, and the second or further light string may be switched on in the event that the temperature falls further below a second threshold value.

It goes without saying that a growing area or vineyard may be provided with only one or a plurality of frost protection systems according to the first aspect of the invention. Indeed, in the case of a growing area or vineyard of large dimensions, several frost protection systems may be used next to one another in parallel, in which each system will protect a portion of the new planting or a portion of all of the grapevines.

The same applies for plantations of kiwifruit plants, fruit trees and shrubs, such as apple trees, pear trees, olive trees, banana plants, trees of the genus Prunus, such as plum trees, apricot trees, nectarine trees, sweet cherry trees, sour cherry trees and preferably trees or shrubs in the form of espaliered trees or shrubs.

According to some embodiments, the power supply may comprise a generator.

For example, the generator may be a diesel generator that generates the required power, which may be DC or AC, at the correct voltage (for example low voltage, for example 12 V or 24 V) or AC (for example 230 V).

According to some embodiments, the power supply may comprise at least one photovoltaic cell and a battery for storing energy collected by the photovoltaic cell.

The one or more photovoltaic cells can produce energy during the daytime, which energy is stored in one or more batteries.

The power supply may comprise both a generator and one or more photovoltaic cells and a battery. Depending on the presence of energy in the battery, the power supply may first use all or some of the energy in the battery, after which it may switch over to energy delivered by the generator. A converter is potentially provided in order to convert the voltage from the battery to the employed voltage and the current type (AC/DC).

According to some embodiments, the power supply may comprise a connection to the electricity distribution grid.

The power supply may simultaneously comprise a grid connection, a generator and/or one or more photovoltaic cells and a battery. Depending on the presence of a battery, and the presence of energy in the battery, the power supply may first use all or some of the energy in the battery, after which it may switch over to energy delivered by the generator. If the generator is not or no longer able to supply the required power, the power supply may switch over to power taken via the connection to the grid.

It goes without saying that the power supply may comprise the necessary additional elements, such as current limiters, converters and the like. The power supply potentially also comprises a dimmer, which may (partially) dim the supply of power to the light strings depending on the measured temperature. By controlling the power supply depending on the measured temperature, energy may be used in a more economical manner.

According to some embodiments, the thermal control unit may comprise a thermometer that generates an electrical signal related to the measured temperature. This signal may simply switch the power supply to the light string on or off depending on a measured temperature. It may switch the power supplies on when the measured temperature is below a given temperature, and switch them off when the measured temperature rises above this given temperature. It may switch the power supplies on when the measured temperature is below a given first temperature, and switch them off when the measured temperature rises above this given second temperature. The second given temperature is preferably higher than the first measured temperature.

On the basis of this signal, the power supply may be switched on or off and/or the amount of delivered electrical energy potentially controlled, depending on the prevailing temperature in the growing area, the vineyard or plantation. The thermometer may measure the temperature in the growing area, the vineyard or the plantation, preferably at the location that is most susceptible to cold.

In the case of a frost protection system for a vineyard or plantation, the one or more measurement points must be sufficiently within the vineyard or plantation to be able to provide a relevant measurement, but also far enough away from the system itself so that the warmth from the light strings does not affect the measurement. For example, this may be between the accesses of the rows, which are openings in rows of grapevines or plantings along which the winegrower or other worker may walk through the rows of grapevines or plantings. This opening is usually made after a given row length, for example every 30 or 50 meters, or for example halfway along a row so that a person can easily change row without having to walk all the way around. The opening is usually one meter wide. The measurement point may easily be placed at a height of 60 cm in these accesses without being affected by the system itself.

In the case of a frost protection system for growing areas for crops, the measurement points are preferably located at ground height and between the rows of new plantings in the growing area.

According to some embodiments, the thermal control unit may comprise a switch that switches on the power supply if the temperature falls below a first predetermined temperature.

According to some embodiments, the thermal control unit may comprise a switch that switches off the power supply if the temperature rises above a second predetermined temperature.

The first and second temperatures may, but do not have to be, the same.

According to some embodiments, the power supply may comprise a current regulator that regulates the flow of current depending on the measured temperature.

The frost protection system possibly comprises more than one light string, and the thermal control unit also possibly comprises more than one thermometer. The thermal control unit may measure the temperature at various locations in the vineyard or plantation and have the generated signal depend on a routine that takes the measured temperatures into account. Thus, for example, the lowest temperature of the measured temperatures, or the mean of the measured temperatures, may be used to generate the control signal.

When the frost protection system comprises more than one light string, the thermal control unit may control all of the light strings equally. Potentially, one of the plurality of measured temperatures may be used to control one or more of the light strings, and another measured temperature may be used to control one or more other light strings. Each light string is possibly controlled by a separate, designated temperature measurement from a designated thermometer.

Potentially, the light strings are routed in pairs, in trios or in groups of four or more to the new growth or new planting to be protected, such as fruit-bearing grapevine laterals.

According to a fourth aspect of the invention, a method for protecting new growth or new plantings from frost is provided. According to a first important facet of this fourth aspect of the invention, a method for protecting new growth or new plantings from frost comprises the steps of

a. providing at least one light string at the level of new growth or a new planting;

b. supplying the at least one light string with electrical power in order to illuminate the new growth or new planting with light from the light string thereby.

The light strings may be light garlands, light ropes and/or light strips. Each of these one or more light strings possibly comprises at least four lights per linear meter, for example between five and 100 lights per linear meter, e.g. between 20 and 80 lights per linear meter, preferably 30 to 80 lights per linear meter, more preferably 40 to 80 lights per linear meter.

According to a second important facet of this fourth aspect of the invention, a method for protecting new growth or new plantings from frost comprises the steps of

a. providing at least one light rope at the level of new growth or a new planting;

b. supplying the at least one light string with electrical power in order to illuminate the new growth or new planting with light from the light string thereby.

According to a third important facet of this fourth aspect of the invention, a method for protecting new growth or new plantings from frost comprises the steps of

a. providing at least one light strip at the level of new growth or a new planting;

b. supplying the at least one light string with electrical power in order to illuminate the new growth or new planting with light from the light string thereby.

According to some embodiments, the new growth or new planting may be new shoots on the fruiting laterals of grapevines.

According to a fourth important facet of this fourth aspect of the invention, a method for protecting new growth or new plantings from frost comprises, comprising the steps of

a. providing a frost protection system according to the first, second and/or third aspect of the invention;

b. providing at least one light string, namely a light garland, light rope or light strip, of the frost protection system at the level of the new growth or new planting;

c. supplying the at least one light string, namely a light garland, light rope or light strip, with electrical power in order to illuminate the new growth or new planting with light from the light string, namely a light garland, light rope or light strip, thereby.

According to some embodiments, the new growth or new planting may be new shoots on the fruiting laterals of grapevines.

At the level of the fruiting lateral, also called the fruiting cordon, this means that the light string is in the vicinity of, against or even around the fruiting lateral.

According to some embodiments, the distance between light string and new growth or new planting may be not more than 20 cm.

Preferably, the distance between light string and new growth or new planting, for example the fruiting lateral, is not more than 10 cm, such as not more than 5 cm.

According to some embodiments, the method may comprise the step of measuring the surrounding temperature, and supplying electrical power to the at least one light string of the frost protection system at the level of the fruiting laterals of one or more grapevines if the measured temperature is lower than a first predetermined temperature.

Preferably, this first temperature is between 0 and 7° C., more specifically between 1 and 5° C., such as between 1 and 4° C.

According to some embodiments, the method may comprise the step of measuring the surrounding temperature, and switching off the supply of electrical power to the at least one light string of the frost protection system at the level of the fruiting laterals of one or more grapevines if the measured temperature is higher than a second predetermined temperature.

Preferably, this second temperature is between 0 and 10° C., more specifically between 2 and 7° C., such as between 2 and 4° C.

The second predetermined temperature is higher than or equal to the first predetermined temperature.

According to some embodiments, the amount of electrical power delivered to the light string may be dependent on the measured temperature.

According to some embodiments, a minimum amount of electrical power may be delivered to the light string in the case of a measured temperature equal to a first predetermined temperature, and wherein the electrical power is gradually increased in the case of decreasing measured temperature, until a maximum amount of electrical power is delivered to the light string in the case of a measured temperature equal to or lower than a third predetermined temperature, wherein the third predetermined temperature is lower than the first predetermined temperature.

The minimum amount of electrical power is equal to the minimum current intensity required for the lights of the light string to function. The maximum amount of electrical power is equal to the current intensity required for the lights of the light string to emit light at their brightest.

Preferably, this third temperature is between −4 and 1° C., more specifically between −4 and −1° C., such as between −4 and −2° C.

According to a fifth aspect of the invention, the use of a light string for protecting new growth or new plantings from frost is provided. The light string may be a light garland, a light rope or a light strip. This light string possibly comprises at least four lights per linear meter, for example between five and 100 lights per linear meter, e.g. between 20 and 80 lights per linear meter, preferably 30 to 80 lights per linear meter, more preferably 40 to 80 lights per linear meter.

According to a sixth aspect of the invention, the use of a frost protection system according to the first, second or third aspect of the invention for protecting new growth or new plantings from frost is provided. According to some embodiments, the new growth or new planting may be new shoots on the fruiting laterals of grapevines. According to some embodiments, the new growth or new planting may be new shoots on the fruiting laterals of kiwifruit plants, fruit trees and shrubs, such as apple trees, pear trees, olive trees, banana plants, trees of the genus Prunus, such as plum trees, apricot trees, nectarine trees, sweet cherry trees, sour cherry trees and preferably trees or shrubs in the form of espaliered trees or shrubs.

According to some embodiments, the use of a light string for protecting new growth or new plantings from frost may comprise the use of a frost protection system according to the first, second or third aspect of the invention.

According to some embodiments, the new growth or new planting may be new shoots on the fruiting laterals of grapevines, on the fruiting laterals of kiwifruit plants, fruit trees and shrubs, such as apple trees, pear trees, olive trees, banana plants, trees of the genus Prunus, such as plum trees, apricot trees, nectarine trees, sweet cherry trees, sour cherry trees and preferably on the fruiting laterals of trees or shrubs in the form of espaliered trees or shrubs.

The invention has a number of advantages over the methods known in the prior art for protecting new growth or new plantings, such as new shoots on fruiting laterals of grapevines, from frost.

The light source of the light string that is used according to the invention may be arranged very close to the new growth or new planting, for example new, fruit-bearing shoots on the fruiting laterals or fruiting cordons. In this way, very efficient energy use is possible. Moreover, in some embodiments, the amount of delivered energy may be matched to the temperature drop that has to be compensated for (i.e. the difference between measured surrounding temperature and predetermined minimum temperature to which a shoot may be exposed).

The radiation warms the new growth or new planting, for example the shoot itself, rather than the air. The system generates warmth only where it is needed, i.e. in the irradiated locations, namely the new growth or new planting, such as the fruiting laterals and the new fruit-bearing shoots. By warming locally, there is also no convection needed to obtain warmed air at the location of the new growth or new planting, such as the new shoots.

The system is straightforward to put in place and remove. To protect grapevines, the light strings may simply be suspended via hooks or the like from the wires to which the fruiting laterals are also attached. For new growth or new plantings on the ground, the light strings may simply be laid next to the new growth or new planting. The system is also easy to use, given that it is easy to see when the system has come into operation.

The system may be used during both advection frost and radiation frost.

Features of one of the aspects of the invention may be combined with features of the other aspects of the invention.

Numbers and ranges that are mentioned within the context of this invention are always inclusive, unless explicitly stated otherwise.

The independent and dependent claims indicate specific and preferred features of the embodiments of the invention. Features of the dependent claims may be combined with features of the independent and dependent claims, or with features as described above and/or below, in any suitable manner which is evident to a person skilled in the art.

The abovementioned and other features, properties and advantages of the present invention will be explained with reference to the following exemplary embodiments, in some cases in combination with the drawings.

The description of these exemplary embodiments is given as clarification, without the intention of restricting the scope of the invention. The reference symbols in the following description refer to the drawings. The same reference symbols in different figures refer to identical or equivalent elements.

### BRIEF DESCRIPTION OF THE FIGURES

With a view to giving a more detailed description of the features of the invention, several preferred embodiments are described below by way of non-limiting example with reference to the attached drawings, in which:

FIG. 1 schematically shows a frost protection system for protecting grapevines from frost.

FIG. 2 schematically shows a top view of a frost protection system for protecting grapevines from frost in a vineyard.

FIG. 3 schematically shows a frost protection system for protecting new plantings.

### DESCRIPTION OF EXEMPLARY EMBODIMENTS

The present invention is described below with reference to specific embodiments.

It should be noted that the term “comprising”, as used, for example, in the claims, should not be interpreted in a limiting sense, limited to the elements, features and/or steps mentioned thereafter. The term “comprising” does not exclude the presence of other elements, features or steps.

Thus the scope of an expression “an object comprising the elements A and B” is not limited to an object that only contains the elements A and B. The scope of an expression “a method comprising the steps A and B” is not limited to a method that only contains the steps A and B.

In the light of the present invention, these expressions only mean that the relevant elements and steps, respectively, are the elements and steps A and B, respectively, for the invention.

In the following specification, reference is made to “an embodiment ” or “the embodiment”. Such a reference means that a specific element or feature, described by means of this embodiment, is comprised in at least this one embodiment.

However, the use of the terms “in an embodiment” or “in the embodiment” at various points in this description does not necessarily refer to the same embodiment, although it may nevertheless refer to the same embodiment.

Furthermore, the properties or the features may be combined in one or more embodiments in any suitable manner, as will be clear to those skilled in the art.

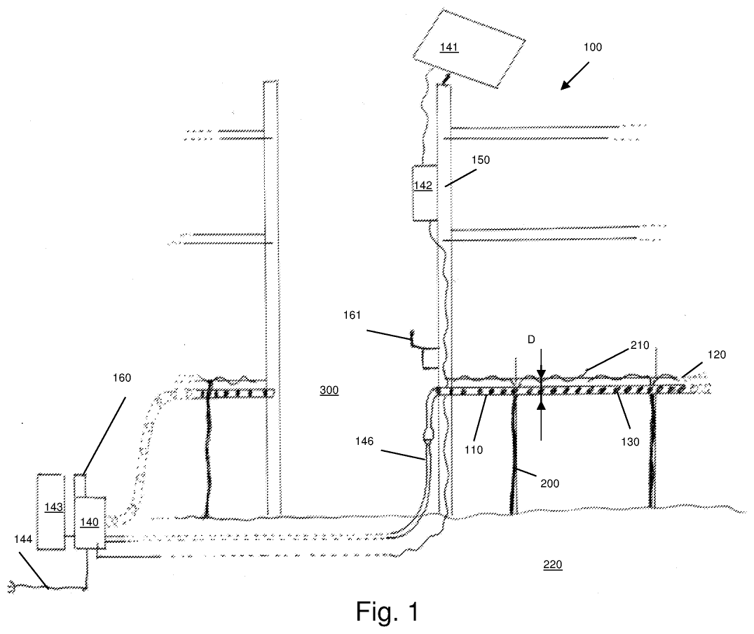

A frost protection system 100 for protecting grapevines 200 from frost is shown in FIG. 1 and comprises a light string 110 for irradiating grapevine fruiting laterals 210 to be protected from frost. The light string is suspended by hooks from the bottommost wire 120 to which the fruiting laterals 210 are also attached.

In a first embodiment, the light string 110 is a light rope, for example from HQ Power. It comprises 70 incandescent bulbs 130 per linear meter, and is suspended approximately 60 cm above the ground 220 of the vineyard. The distance D between the fruiting laterals 210 and the light rope 110 is preferably smaller than 10 cm. The light rope has a diameter of approximately 2 cm. In total, the light rope is 45 m long and a plurality of, for example 45, grapevines 200 growing next to one another, with a distance of one meter between them, may be protected. It goes without saying that the length of the light rope may vary, for example between 30 and 50 m, depending on the length of the row of grapevines that is protected by the light rope. The outside of the light rope is made from transparent polymer. The power of the light rope is preferably between 10 and 20 watts per linear meter. The light rope operates on 230 V AC.

The system 100 further comprises a power supply 140 for supplying the light strings with electrical power. This supply 140 may comprise a photovoltaic cell 141 (or PV cell) that is connected to a battery 142 and potentially to a converter. The cell 141 may be mounted on one of the large supporting posts 150. The power supply 140 may also comprise, instead of or in addition to this PV cell and battery, a power generator 143, which may be fuelled by diesel or gasoline. Potentially, the power supply 140 also comprises a connection 144 to the electrical power grid.

The light string 110 is connected to the output of this power supply 140. For example, this connection may be made using a powerCON TRUE1 from Neutrik. Potentially, one or more extension cables 146 are provided between the light string and the power supply.

The power supply potentially further comprises a dimmer, for example a frequency controller, for varying the current intensity to the light string.

The frost protection system further comprises a thermal control unit 160 for controlling the power supply on the basis of measured temperature. This temperature measurement is taken by a thermometer 161. An example of a thermal control unit is a Crodeon Reporter from Crodeon Technologies. The thermometer in FIG. 1 is provided on the supporting post 150 at the level of the supporting wire 120. In alternative embodiments, the thermometer may be at ground height or hung at the level of the top of the supporting post 150. Potentially, a plurality of thermometers are distributed over the vineyard and these are not necessarily hung at the height of the first supporting post. As can be seen in FIG. 1, the thermometer may be hung at the level of the accesses 300 in the rows of grapevines. A vineyard may be divided into rows of grapevines, which rows are divided into sections. Each section may be served by one thermometer and one light rope which is suspended at the level of the supporting wire of that section. The thermal control unit 160 and one or more thermometers 161 may be coupled to one another via telecommunication or via a signal cable. Obviously, the distance between thermometer and light string is great enough for the light string not to affect the measured temperature.

In an alternative embodiment, the light rope is replaced with a light strip. It comprises 120 LEDs per linear meter. The light strip has a width of approximately 1.5 cm. The outside of the light strip is made from white polymer. The power of the light strip is between 10 and 20 W per linear meter. The average wavelength of the emitted light is approximately 700 nm, for example. In yet another alternative embodiment, the light rope is a light rope that comprises 36 lights per linear meter. The operation of the frost protection systems described above is almost identical. The thermometer preferably measures the surrounding temperature at the level of the first supporting wire where the new growth will grow on the fruiting laterals (at a height of approximately 60 cm), and this will be done at one or more locations in the vineyard. In the case of a plurality of simultaneous temperature measurements, the measured temperature is determined or calculated from the measurements, for example by averaging or by choosing the lowest measured temperature. As long as this temperature stays above a first predetermined temperature of 4° C., for example, nothing happens. As soon as the measured temperature falls below 4° C., the power supply will be switched on, i.e. the energy in the battery 142 will be drawn upon, or the power generator 143 will be activated, or the grid power 144 will be connected to the light string 110.

Potentially, the power supply will adjust the current intensity depending on the measured temperature. Thus, for example, the delivered electrical power may be gradually increased as the measured temperature decreases, until a predetermined temperature of, for example, 0° C. is reached. From that point the amount of delivered electrical power is at maximum.

The light string stays on and supplied with electrical power until the surrounding temperature has risen again sufficiently, for example to a predetermined switching-off temperature of 2° C. If the measured temperature reaches this value, the power supply is switched back off. Potentially, the amount of delivered electrical power may be gradually decreased as the measured surrounding temperature increases again.

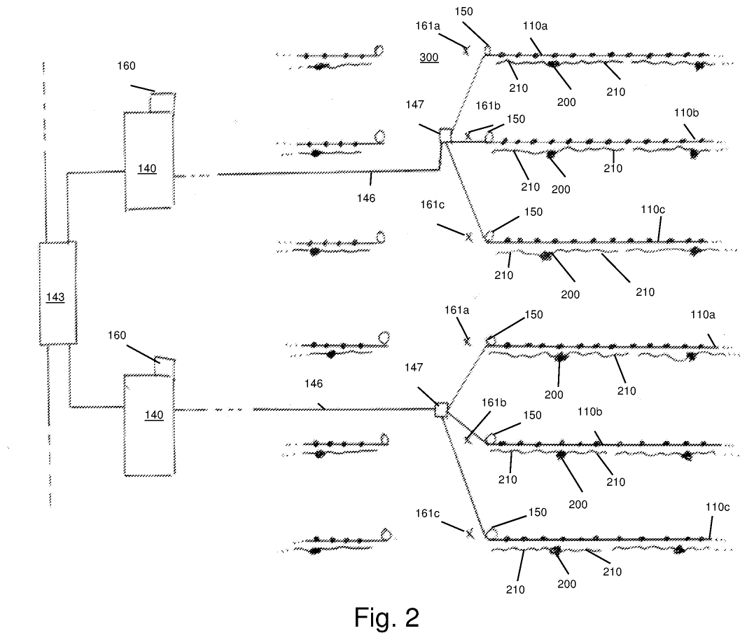

FIG. 2 schematically shows how a frost protection system in a vineyard may look. The vineyard is grouped into groups of three rows of grapevines. Three rows of grapevines 200, each with their fruiting laterals 210 suspended approximately 60 cm above the ground, are served by one power supply 140, temperature control unit 160 and light strings (110a, 110b and 110c). Each row of grapevines has one light string (110a, 110b or 110c) at the level of the fruiting laterals 210 or fruiting cordons. This is connected to the power supply 140 via an extension cable 146 and a junction box 147. Via three thermometers 161a, 161b and 161c, temperatures are measured at the level of the fruiting laterals 210, which should represent the surrounding temperature. From these three measured values, the coldest temperature is selected by temperature control unit 160. The light strings 110a, 110b and 110c are activated and supplied with power if the temperature gets too low and falls below a predetermined threshold temperature. In these embodiments, all of the power is supplied by a diesel generator 143. The light strings are connected to a junction box using powerCON TRUE1 connectors. The same applies for the extension cable and junction box and extension cable and power supply.

It goes without saying that many alternatives to this scheme may be envisaged. The rows of grapevines may be grouped into groups of two rows, three rows, four rows, five rows or more rows. Just one temperature measurement may be taken per group of rows of grapevines, or the mean temperature may be calculated from a plurality of temperature measurements. More than one generator may be provided, or grid power may also be provided, potentially in combination with these one or more generators.

In yet another alternative, more than one light string may be provided per row of grapevines, which may be connected in parallel or one after the other.

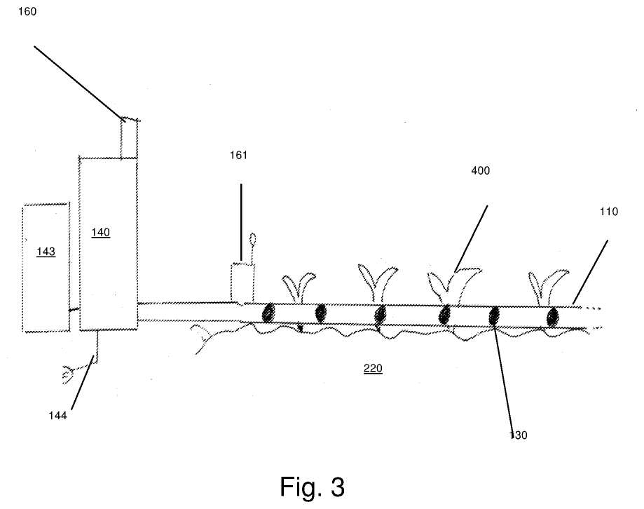

In FIG. 3, a frost protection system is provided in a growing area where new plantings 400 of crops are grown. All of the elements shown in FIG. 3 are identical to those described for FIG. 1. The light string is laid on the ground 220, and the thermometer 161 measures the temperature on the ground. Obviously, the distance between thermometer and light string is great enough for the light string not to affect the measured temperature.

It is clear that although the embodiments and/or materials for obtaining embodiments according to the present invention are discussed, various modifications or amendments may be made without deviating from the functional scope and/or spirit of this invention. The present invention is by no means limited to the above-described embodiments, but may be realized according to different variants without departing from the scope of the present invention.

1-42. (canceled)

43. A frost protection system for protecting new growth or new plantings from frost, the system comprising:
one or more light strings for irradiating the new growth or new planting to be protected from frost;
a power supply for supplying the light strings with electrical power;
a thermal control unit for controlling the power supply on the basis of measured temperature
wherein the one or more light strings have at least four lights per linear meter.

44. The frost protection system according to claim 43, wherein the light string has between five and 100 lights per linear meter.

45. The frost protection system according to claim 43, wherein the light string has a power of between 10 and 50 watts per linear meter.

46. The frost protection system according to claim 43, wherein the light string has lights that comprise incandescent bulbs, infrared incandescent bulbs, halogen bulbs, LED bulbs or infrared LED bulbs

47. The frost protection system according to claim 43, wherein the maximum intensity of the emitted light is in the infrared range.

48. The frost protection system according to claim 43, wherein the light string is a light garland, a light rope, a light strip or a light strip wherein lights are present on both sides of the light strip.

49. The frost protection system according to claim 43, wherein the frost protection system is a system for protecting new growth on grapevines from frost.

50. The frost protection system according to claim 43, wherein the power supply comprises a generator and/or at least one photovoltaic cell and a battery for storing energy collected by the photovoltaic cell, and/or a connection to the electricity distribution grid.

51. The frost protection system according to claim 43, wherein the thermal control unit comprises a thermometer that generates an electrical signal related to the measured temperature.

52. The frost protection system according to claim 43, wherein the thermal control unit comprises a switch that switches on the power supply if the temperature falls below a first predetermined temperature.

53. The frost protection system according to claim 52, wherein the thermal control unit comprises a switch that switches off the power supply if the temperature rises above a second predetermined temperature.

54. A method for protecting new growth or new plantings from frost, comprising the steps of:
a) providing at least one light string at the level of new growth or a new planting;
b) supplying the at least one light string with electrical power in order to illuminate the new growth or new planting with light from the light string thereby.

55. The method according to claim 54, wherein the light string is a light garland, a light rope or a light strip.

56. The method according to claim 54, wherein the light string has at least four lights per linear meter.

57. A method for protecting new growth or new plantings from frost, comprising the steps of:
a) providing a frost protection system according to claim 43;
b) providing at least one light string of the frost protection system at the level of new growth or a new planting;
c) supplying the at least one light string with electrical power in order to illuminate the new growth or new planting with light from the light string thereby.

58. The method according to claim 57, wherein the new growth or new planting is new shoots on the fruiting laterals of grapevines.

59. The method according to claim 57, wherein the distance between light string and new growth or new planting is not more than 20 cm.

60. The method according to claim 57, wherein the method comprises the step of measuring the surrounding temperature, and supplying electrical power to the at least one light string of the frost protection system at the level of the fruiting laterals of one or more grapevines if the measured temperature is lower than a first predetermined temperature.

61. Use of a light string for protecting new growth or new plantings from frost.

62. The use according to claim 61, wherein the new growth or new planting is new shoots on the fruiting laterals of grapevines.
